(19) United States
(12) Patent Application Publication
(10) Pub. No.: US 2026/0024447 A1
(43) Pub. Date: Jan. 22, 2026

(54) BACKEND API SOLUTION THAT PROVIDES HIGH-QUALITY, STRUCTURED ARTICLES TO IMPROVE STUDENTS' READING COMPREHENSION SKILLS

(71) Applicant: 2hr Learning, Inc., Austin, TX (US)

(72) Inventors: Andy Montgomery, Austin, TX (US); Ege Altan, Austin, TX (US); Sean Crosby, Austin, TX (US); Kyle McGraw, Austin, TX (US)

(73) Assignee: 2hr Learning, Inc., Austin, TX (US)

(21) Appl. No.: 19/273,062

(22) Filed: Jul. 17, 2025

Related U.S. Application Data
(60) Provisional application No. 63/672,382, filed on Jul. 17, 2024.

(51) Int. Cl. G09B 5/02; G06F 40/253

(52) U.S. Cl. CPC G09B 5/02; G06F 40/253

(57) ABSTRACT

A content appropriateness validation system and method for validating content involves receiving content from a content management system 104 and conducting a comprehensive validation in accordance with predetermined metrics or other standards. In at least one embodiment, the standards are stored in a data storage and are inputs so that the programmatic control. The validation includes evaluating against standards such as grammar, coherence, factuality, engagement, age-appropriateness, and topic suitability, as well as identifying and filtering out inappropriate content related to sensitive topics like politics, sex, harassment, violence, hate, and self-harm. The system applies various algorithms and integrates a readability score generator to assess and assign a knowledge grade to the content. The validated content, along with the readability score, is then displayed to users on an online learning platform.

### CROSS-REFERENCE TO RELATED APPLICATION(S)

This application claims the benefit under 35 U.S.C. § 119 (e) and 37 C.F.R. § 1.78 of U.S. Provisional Application No. 63/672,382, which is incorporated by reference in its entirety.

### FIELD OF THE INVENTION

The present invention relates in general to the field of electronics, and more specifically, a system and method for guiding an artificial intelligence (AI) engine for the validation of educational content, which uses an AI engine to validate the content given by a content management system.

### DESCRIPTION OF THE RELATED ART

Educational content systems face significant challenges in maintaining high-quality, accurate, and appropriate materials. Traditional validation processes rely heavily on manual reviews by educators and editors. However, this approach proves time-consuming, prone to human error, and difficult to scale. Manual reviews often fall short of comprehensively assessing engagement levels, age-appropriateness, and topic suitability. The inability to efficiently screen for sensitive subjects like violence or hate speech poses a particular concern, risking the exposure of young learners to inappropriate content.

Peer review systems in educational content validation involve multiple educators examining the same materials. Peer review systems enhance accuracy by leveraging diverse expertise and perspectives. Reviewers carefully assess content for factual correctness, pedagogical soundness, and alignment with curriculum standards. Peer review systems also evaluate the clarity of explanations, the effectiveness of examples, and the appropriateness of difficulty levels. While this peer review system improves content quality, peer review systems significantly extends the validation timeline. Each reviewer requires time to thoroughly examine the material, and coordinating multiple reviews further delays the process. Moreover, as content volume grows, peer review systems struggle to scale efficiently, creating bottlenecks in content production and potentially delaying the release of updated or new educational materials.

Standardized rubrics, or checklists. Content reviewers use these predefined criteria to systematically evaluate materials. Rubrics typically cover various aspects of content quality, such as accuracy, clarity, organization, and alignment with learning objectives. While this approach can bring some consistency to the review process, it still relies heavily on human judgment and can be time-consuming to apply thoroughly. Additionally, rigid rubrics may not easily adapt to diverse content types or evolving educational standards.

Keyword filtering is another conventional method used to screen educational content for sensitive or inappropriate material. The keyword filtering involves creating lists of problematic words or phrases and automatically flagging content that contains them. While keyword filtering can quickly identify obviously inappropriate content, keyword filtering often struggles with context and nuance. The keyword filtering may produce false positives by flagging benign uses of words that can have multiple meanings. Conversely, the keyword filtering may miss sensitive content that uses euphemisms or context-dependent language.

Plagiarism detection software plays a crucial role in maintaining the integrity of educational materials. The plagiarism detection software tools compare submitted content against vast databases of existing texts, websites, and academic papers to identify potential instances of copying. The plagiarism detection software tools flag matching or highly similar passages, allowing reviewers to investigate potential copyright infringements or improper citations. While effective at detecting direct copying, these tools may struggle with paraphrasing or ideas that are common knowledge in a field. The plagiarism detection software tools also cannot determine if properly cited material is used appropriately within the educational context.

### SUMMARY

In at least one embodiment, a method integrates programmatic control and a guided and constrained Artificial Intelligence (AI) engine to validate educational content. The method includes executing code using one or more processors of a computer system to cause the computer system to perform operations. The operations include receiving educational content from a content management system for validation, where the validation includes assessing grammar, coherence, factuality, engagement, age-appropriateness, and topic suitability. The operations include generating a prompt to guide the AI engine for generating validated educational content by conducting thorough quality checks on the educational content. The operations include transferring the prompt to the AI engine to utilize a plurality of algorithms to conduct thorough quality checks on the educational content to ensure the educational content does not contain inappropriate content related to political, sexual, harassment, violence, hate, and self-harm topics. The operations include integrating readability metrics to assess and assign a measured knowledge grade for the educational content. The operations include generating the validated educational content outlining the results of the quality checks and the measured knowledge grade. The operations include displaying the generated educational content to a user on an online learning platform.

In at least one embodiment, a system integrates programmatic control and a guided and constrained Artificial Intelligence (AI) engine to validate educational content. The system includes one or more processors of a computer system and a memory, coupled to the one or more processors, storing code that, when executed, causes the computer system to perform operations. The operations include receiving educational content intended for validation, where the validation includes assessing grammar, coherence, factuality, engagement, age-appropriateness, and topic suitability. The operations include generating a prompt to guide the AI engine for generating validated educational content by conducting thorough quality checks on the educational content. The operations include transferring the prompt to the AI engine to utilize algorithms to conduct thorough quality checks on the educational content to ensure the educational content does not contain inappropriate content related to political, sexual, harassment, violence, hate, and self-harm topics. The operations include integrating readability metrics to assess and assign a measured knowledge grade for the educational content. The operations include generating a detailed report outlining the results of the quality checks and the measured knowledge grade.

### BRIEF DESCRIPTION OF THE DRAWINGS

The systems and methods described herein may be better understood and their numerous objects, features, and advantages made apparent to those skilled in the art by referencing exemplary embodiments depicted in the accompanying figures. The use of the same reference number throughout the several figures designates a like or similar element.

FIG. 1 depicts a system for guiding an artificial intelligence (AI) engine for the validation of content.

FIG. 2 depicts a method for guiding an artificial intelligence (AI) engine for the validation of content.

FIG. 3 depicts the diagram outlining a structured workflow for the method for guiding an AI engine for the validation of content.

FIG. 4 depicts the process flow for a sensitive content check.

FIG. 5 depicts the process flow chart for the validation of content.

FIG. 6 depicts an exemplary network environment in which the system of FIG. 1 and the process of FIG. 2 may be practiced.

FIG. 7 depicts an exemplary computer system.

### DETAILED DESCRIPTION

A content appropriateness validation system and method for validating content involves receiving content from a content management system 104 and conducting a comprehensive validation in accordance with predetermined metrics or other standards. In at least one embodiment, the standards are stored in a data storage and are inputs so that the programmatic control. The validation includes evaluating against standards such as grammar, coherence, factuality, engagement, age-appropriateness, and topic suitability, as well as identifying and filtering out inappropriate content related to sensitive topics like politics, sex, harassment, violence, hate, and self-harm. The system applies various algorithms and integrates a readability score generator to assess and assign a knowledge grade to the content. The validated content, along with the readability score, is then displayed to users on an online learning platform 102.

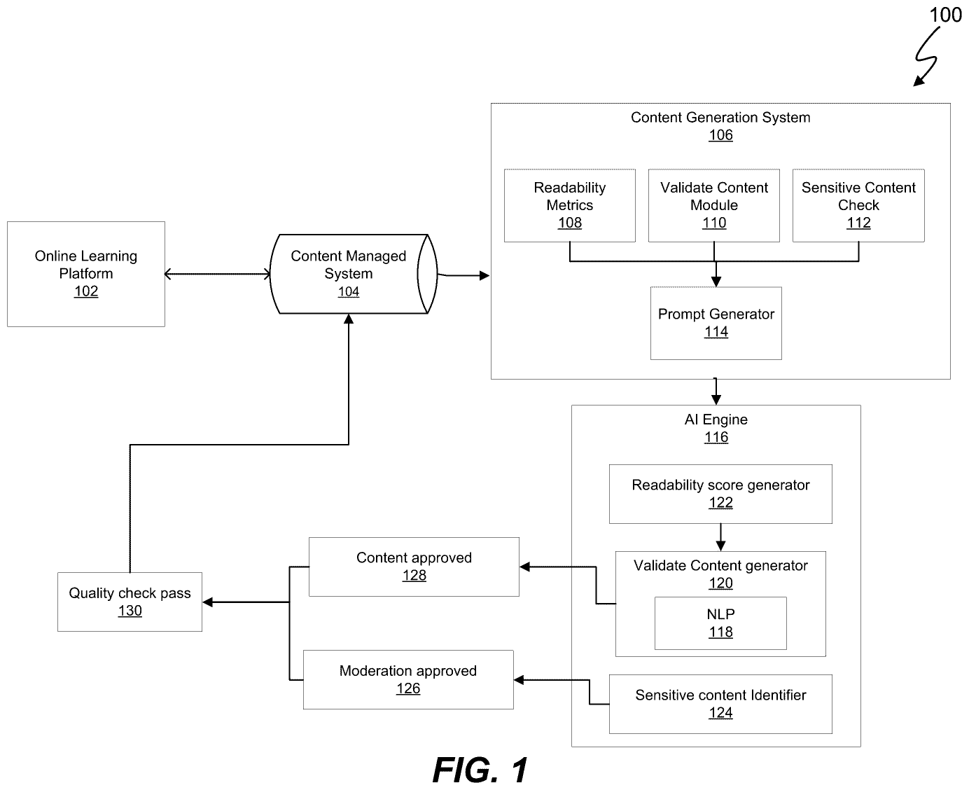

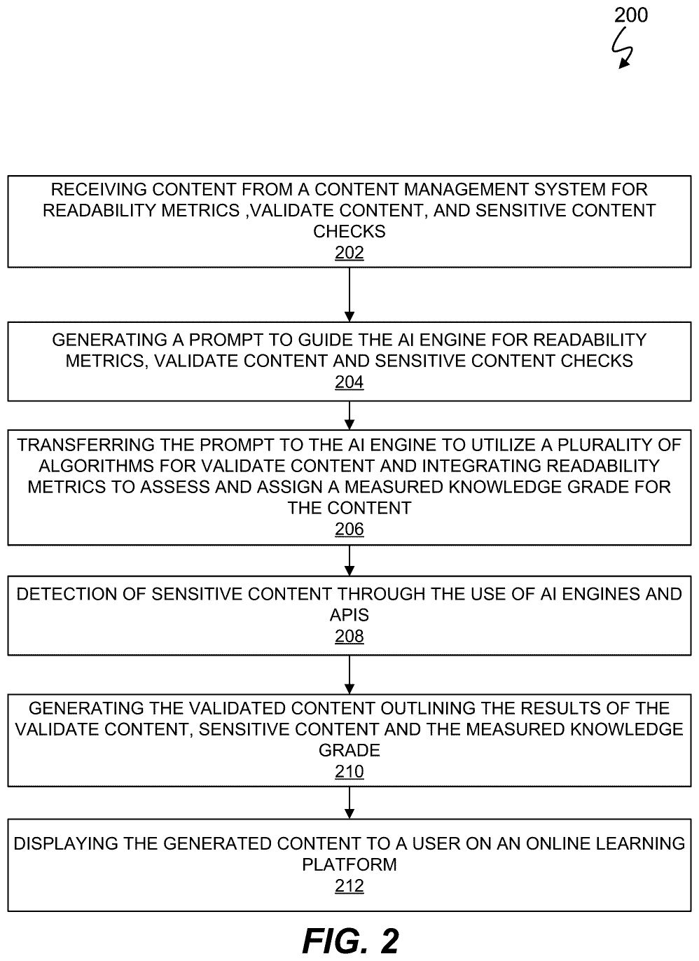

FIG. 1 depicts a content appropriateness validation system 100 for the validation of educational content, given by the content management system 104, and FIG. 2 depicts a method for guiding the AI engine 116 for the validation of content, given by the content management system 104.

In Operation 202, the method for guiding an AI engine for the validation of content. The content generation system 106 receives content from a content management system 104 for sensitive content check, validation of content, and readability metrics. The content generation system 106 comprises a readability metrics 108, a validated content module 110, a sensitive content check 112 and a prompt generator 114. The content generation system 106 directs an AI engine 116 to do all necessary tasks, such as sensitive content check, validation of content, and generate readability metrics scores, and give verified content and scores for deciding whether content needs to be presented on the online learning platform 102.

The content management system 104 collects data from different sources. In an embodiment, the purpose is for educational use. The content management system 104 collects data from the most reliable sources and collects a variety of data from different verticals. For example, the content management system 104 collects information from Wikipedia, new letters, newspapers, articles, surveys, etc. The content management system 104 sorts and stores all the data from different sources.

In operation 204, the prompt generator 114 inside the content generation system 106 generates a prompt to guide the AI engine 116 for generating readability metrics scores, sensitive content checks, and validating content. Readability metrics are quantitative measures used to evaluate the readability of a text. The readability metrics 108 collect aspects of the text, such as sentence length, word complexity, and syllable count, to determine how easy or difficult it is to read. In an embodiment, the readability metrics 108 collect all the relevant data for modifying prompts in prompt generator 114 for creating readability metrics. The readability metrics 108 send data to the prompt generator 114. The prompt generator 114 modifies prompts created by the prompt engineer with the sentence length, word complexity, and syllable count of data received from the readability metrics 108 for calculating the following metrics: Dale Chall Readability, Flesch Kincaid Grade, Gunning Fog, Smog Index, Automated Readability Index (ARI), Coleman Liau Index, and Linscar Write Formula.

The Dale-Chall Readability Test measures text difficulty based on a list of familiar words and calculates a score indicating the required reading level. The Flesch-Kincaid Grade Level estimates the U.S. school grade level needed to understand the text based on sentence length and word complexity. The Gunning Fog Index assesses the number of years of education needed to comprehend a text on the first reading, using sentence length and complex words. The SMOG Index estimates the years of education needed to understand a text by counting the number of polysyllabic words in sentences. The Automated Readability Index (ARI) uses the number of characters per word and words per sentence to calculate the readability level. The Coleman-Liau Index determines readability based on the average number of characters per word and the average sentence length. The Linsear write formula calculates readability for technical documents, focusing on sentence length and the number of words with three or more syllables.

In an embodiment, the prompt generated by the prompt engineer includes calculating the following metrics: Dale Chall Readability, Flesch Kincaid Grade, Gunning Fog, Smog Index, Automated Readability Index (ARI), Coleman Liau Index, and Linscar Write Formula. After calculating the above metrics, the prompt emphasizes AI engine 114 for selecting the least two scores given by the readability metrics. Finally, the AI engine 114 is asked to take the average of the least two scores taken and provide output.

The validated content module 110, validates content across multiple dimensions, including grammar, coherence, factuality, engagement, age-appropriateness, and topic suitability. Grammar refers to the correctness of language use, including syntax, punctuation, and sentence structure, ensuring clear communication. Coherence measures how logically and smoothly ideas are connected within a text, making it easy for readers to follow the argument or narrative. Factuality assesses whether the information presented in the text is accurate, truthful, and based on verifiable facts. Engagement evaluates how well the text captures and maintains the reader's interest, often through compelling content, tone, and style.

Age-appropriateness ensures that the content, language, and themes are suitable for the intended age group, avoiding topics or language that may be too complex or sensitive. Topic suitability determines whether the subject matter is relevant and appropriate for the context, purpose, and audience of the text. The validated content module 110 receives the data from the content management system 104. In an embodiment, the validated content module 110 fetches all the required strings required for the modification of prompts in the prompt generator 114 created by the prompt engineers.

The sensitive content check 112 supports the prompt generator 114 to generate prompts for avoiding content such as sexual, harassment, violence, hate, and self-harm topics in the content received by the content generation system 106. In an embodiment, a prompt generated by the prompt engineer includes all the strings that need to be restricted, such as sexual, harassment, violence, hate, and self-harm topics. The prompt generator 114 replaces the content given by the content management system 104 in the prompt created by the prompt engineer and is given to the AI engine 116.

The sensitive content check 112 also filters political or gender-related content. In an embodiment, the sensitive content check 112 converts the input content from the content generation system 106 into numerical representations. Simultaneously, it transforms keywords related to political and gender-discriminative language into corresponding numerical values. The sensitive content check 112 then utilizes vector comparison techniques to analyze and identify political or gender-related subjects within the content.

For example, the sensitive content check 112 employs vector comparison techniques to identify political or gender-related content. The sensitive content check 112 first converts the input text “The government should implement stricter immigration policies” into a numerical vector, for example [0.2, 0.5, −0.1, 0.8, 0.3]. Simultaneously, it transforms known political keywords like “government,” “immigration,” and “policies” into their own numerical vectors. The sensitive content check 112 then calculates the cosine similarity between the input vector and these keyword vectors. If the similarity score exceeds a predetermined threshold, such as 0.7, the sensitive content check 112 flags the content as potentially political. The vector comparison allows the sensitive content check 112 to efficiently detect and filter content with political overtones, even when exact keyword matches are not present. In an embodiment, the sensitive content check 112 and the prompt generator 114 modify the content given to the prompt. where the prompt is developed by the prompt engineer to identify the political content and gender-related content by converting the received content into numerical code and comparing it by vector comparison.

In operation 206, the prompt is transferred to the AI engine, which utilizes a plurality of algorithms to validate content, measure readability metrics, score, and perform sensitive content checks. The prompt from the content generation system 106 guide validates content generator 120, readability score generator 122 and sensitive content identifier 124 to give the output.

The AI engine 116 is trained through supervised learning for the initial training. In supervised learning, the AI engine 116 begins by training a model using a labeled dataset, where each input is paired with the correct output. The AI engine 116 learns to map inputs to outputs by adjusting its parameters to minimize the error between its predictions and the actual outcomes. During this training phase, the AI engine 116 receives feedback on its performance and iteratively improves its accuracy. By the end of training, the AI engine 116 generalize from the examples it has seen and makes accurate predictions on new, unseen data. This initial training sets the foundation for the AI engines' 116 performance in real-world applications. Continuous improvement is made through reinforcement learning. Reinforcement learning is a type of machine learning where the AI engine 116 learns to make decisions by interacting with its environment. The AI engine 116 takes actions, and based on the outcomes, the AI engine 116 receives rewards or penalties. The AI engine 116 uses this feedback to learn which actions yield the best results over time. The goal of reinforcement learning is to maximize the cumulative reward, which encourages the AI engine 116 to develop strategies that achieve long-term success rather than just immediate gains. By continuously exploring and exploiting the environment, the AI engine 116 improves its performance and becomes more adept at solving complex problems.

In the AI engine 116, readability is calculated by first analyzing the text using various readability metrics to assess its complexity and the educational level required to understand. The AI engine 116 applies metrics such as Dale-Chall Readability Test, Flesch-Kincaid Grade Level, Gunning Fog Index, SMOG Index, Automated Readability Index (ARI), Coleman-Liau Index, and Linsear Write Formula. After these metrics are calculated, the AI engine 116 identifies the two lowest scores, which represent the least complex readability levels. The AI engine 116 then averages these two scores to provide a final readability score.

The content from the readability score generator 122 is sent to the validate content generator 120. For the validation of content, the validate educational content generator 120 inside AI engine 116 uses a NLP 118 (natural language processing). In an embodiment, the NLP 118 techniques are applied to analyze text by systematically breaking down and understanding its various components. The NLP 118 starts by parsing sentences to identify grammatical structures, such as subject-verb relationships, and ensuring that the text adheres to proper syntax. Next, the NLP 118 assesses coherence by examining how ideas flow and connect across sentences and paragraphs, ensuring the content makes logical sense. To evaluate factuality, NLP tools compare the information in the text against reliable data sources, checking for accuracy and truthfulness. Engagement is gauged by analyzing the language used and determining if the content is likely to captivate and hold the reader's attention. Age-appropriateness is assessed by evaluating the vocabulary and themes, ensuring they match the intended audience's cognitive level. Finally, topic suitability is determined by examining whether the content aligns with the intended subject matter or domain. By integrating these analyses, the NLP 118 provides a comprehensive evaluation of the text, ensuring it is well-structured, relevant, and appropriate for its intended users. The readability score from the readability score generator 122 along with the validated content from the validate content generator 120 is sent to a content-approved 124 information module.

In operation 208, detecting sensitive content in the content, the sensitive content contains sexual, harassment, violence, hate, self-harm topics, self-harm intent, self-harm instruction, violence/graphic, sexual/minors, hate/threatning, harassment/threatening, politics, and genter identity. In an embodiment, an openAI content moderation API is used for the identification of sexual harassment, violence, hate, self-harm topics, self-harm intent, self-harm instruction, violence/graphics, sexual minors, Hate/threatning and harassment/threatening. The OpenAI content moderation API developed by OpenAI is designed to identify and filter harmful or inappropriate content within the online learning platform 102. By leveraging advanced machine learning models, the API analyzes text and flags content that may contain hate speech, violence, harassment, self-harm, or other forms of harmful language. By integrating this API into the online learning platform 102 to automatically monitor content in real time.

To identify gender identity flags and political flags, the sensitive content identifier 124 converts the text into a coded format. sensitive content identifier 124 also converts sensitive words related to gender identity and political flags into codes. The sensitive content identifier 124 then performs a vector comparison between the coded text and the coded sensitive words. By analyzing this comparison, the sensitive content identifier 124 determines if any content related to gender identity or political flags is present. For example, if a user submits a post stating, “The new laws support transgender rights,” the sensitive content identifier 124 immediately transforms this sentence into a coded format. At the same time, sensitive content identifier 124 has data on sensitive words like “transgender” and “laws,” which sensitive content identifier 124 also converts into vectors. The sensitive content identifier 124 then actively compares the vectors of the user's text with the sensitive word vectors. Upon finding a close match between “transgender” and “laws” in the vectors, the sensitive content identifier 124 flags the content for containing references to gender identity and political topics.

In operation 210, the validated content outlining the results from the readability score generator 122, the validate content generator 120 and the sensitive content identifier 124. The readability score from the readability score generator 122 and content from the validate content generator 120 is shared with the content approved 128. The sensitive content identifier 124 shares the content with a moderation approved 126. The content and score from the approved content 124 and the moderation approved 126 are passed to a quality check pass 130. The quality check pass 130 determines whether the content should be shown on the online learning platform through the content management system 104.

In operation 212, the system displays the generated content and readability score to a user on the online learning platform 1-2. The quality check pass 130 decides whether to show the content to the user on the online learning platform. This decision is based on the content's readability score and sensitivity. If the quality check pass 130 approves the display, the content management system 104 will present the content on the online learning platform 102 or else the content management system 104 will not present the content on the online learning platform 102.

```
# Pseudo-code programmatic control of the AI Engine 116 by the Content Generation System
106:
function qualityControl(article):
    # Initialize a score dictionary to hold quality scores
    qualityScores = { }
  # Check grammar using AI and store the score
    qualityScores[‘grammar’] = checkGrammar(article.content)
  # Check coherence using AI and store the score
    qualityScores[‘coherence’] = checkCoherence(article.content)
  # Check factuality using AI and store the score
    qualityScores[‘factuality’] = checkFactuality(article.content)
  # Check engagement level using AI and store the score
  qualityScores[‘engagement’] = checkEngagement(article.content,
article.ageGrade)
  # Check for age-appropriateness using AI embeddings and OpenAI moderator
API
  qualityScores[‘ageAppropriateness’] =
checkAgeAppropriateness(article.content, article.ageGrade)
  # Check topic suitability using AI and store the score
  qualityScores[‘topicSuitability’] =
checkTopicSuitability(article.content, article.knowledgeTags)
  # Perform structural checks based on predefined article structure
    qualityScores[‘structure’] = checkStructure(article)
  # Validate guiding questions and quizzes for relevance and alignment with
grade level
  qualityScores[‘guidingQuestions’] =
validateGuidingQuestions(article.sections)
  qualityScores[‘quizzes’] = validateQuizzes(article.quiz)
  # Return the overall quality score based on individual checks
    return calculateOverallQualityScore(qualityScores)
# Helper functions used within the qualityControl function
function checkGrammar(content):
  # AI algorithm to check for grammatical errors
  # Returns a score based on the number and severity of errors found
function checkCoherence(content):
    # AI algorithm to evaluate the logical flow and coherence of the text
    # Returns a score based on the coherence of the content
function checkFactuality(content):
    # AI algorithm to verify the factual accuracy of the content
    # Returns a score based on the accuracy of the information presented
function checkEngagement(content, ageGrade):
    # AI algorithm to assess the engagement level of the text for the
specified age grade
    # Returns a score based on how engaging the content is for the target
audience
function checkAgeAppropriateness(content, ageGrade):
    # Uses AI embeddings and OpenAI moderator API to filter out inappropriate
content
    # Returns a boolean indicating whether the content is age-appropriate
function checkTopicSuitability(content, knowledgeTags):
    # AI algorithm to ensure the content is suitable for the provided
knowledge tags
    # Returns a score based on the relevance and suitability of the content
for the tags
function checkStructure(article):
    # Deterministic algorithm to check if the article meets the predefined
structure
# Returns a boolean indicating whether the article passes the structural
check
function validateGuidingQuestions(sections):
    # AI algorithm to validate the relevance and alignment of guiding
questions with the content
    # Returns a score based on the quality of the guiding questions
function validateQuizzes(quiz):
    # AI algorithm to validate the relevance and alignment of quiz questions
with the content
    # Returns a score based on the quality of the quiz questions
function calculateOverallQualityScore(qualityScores):
    # Aggregates individual quality scores into an overall score
    # Returns the overall quality score for the article
```

The above mentioned pseudo-code outlines programmatic control of the AI Engine 116 and the validate content generator 120 for validated content module for educational contents. The main function, ‘qualityControl’, takes educational content as input and performs various checks to assess its validity. The function begins by initializing a dictionary called ‘qualityScores’ to store the results of different validity checks. Main function, qualityControl then calls several helper functions to evaluate different aspects of the contents:
‘checkGrammar’ analyzes the content for grammatical errors. ‘checkCoherence evaluates the logical flow and coherence of the text. ‘checkFactuality’ verifies the accuracy of the information presented. ‘checkEngagement’ assesses how engaging the content is for the target age group. ‘checkAgeAppropriateness’ or the sensitive content identifier 124 uses AI embeddings and the OpenAI moderator API to ensure the content is appropriate for the specified age grade. ‘checkTopicSuitability’ ensures the content aligns with the provided knowledge tags. ‘checkStructure’ verifies that the article meets a predefined structure. Each of these helper functions returns a score or boolean value, which is stored in the ‘qualityScores’ dictionary. After all checks are complete, the function calls ‘calculateOverallQualityScore’ to aggregate the individual scores into an overall quality score for the article. This AI-driven validated content module provides a comprehensive evaluation of content validity, considering factors such as grammar, coherence, factual accuracy, engagement, age-appropriateness, topic suitability, structure, and the quality of associated questions and quizzes.

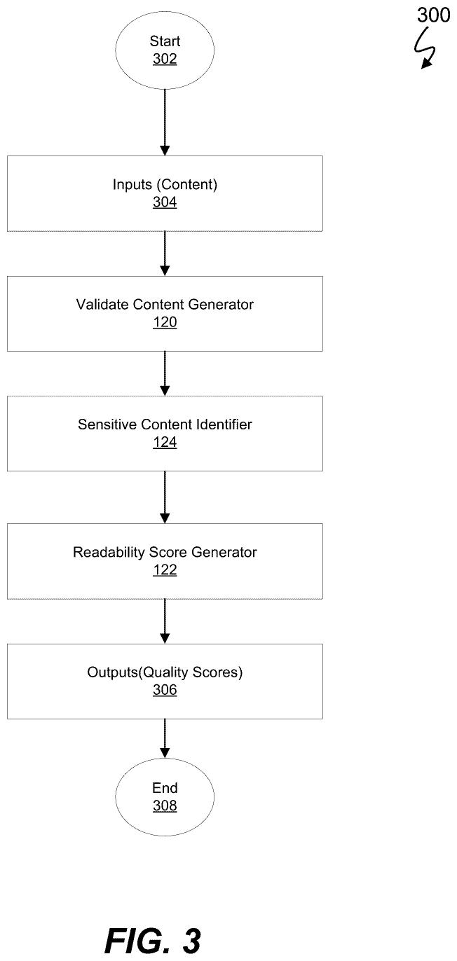

FIG. 3 depicts the diagram outlining a structured workflow for the method for guiding an AI engine for the validation of content 300. Method for guiding an AI engine for the validation of content, starting with the initiation at the “Start 302” node. progresses to the Inputs 304 stage, where different contents are provided. The method for guiding an AI engine 116 for the validation of content then advances to the AI engine 116, which uses validate content generator 120 to evaluate different aspects of the content, including grammar, coherence, factual accuracy, and engagement. Following this, the content is sent to the Sensitive content identifier 124 for a check on sensitive topics, ensuring that it meets appropriate standards for the user. Next, the article moves to the readability score generator 122 phase, where the readability score generator 122 calculates how accessible and understandable the text is for its intended user. The method for guiding an AI engine for the validation of content culminates at Outputs node 306, where quality scores are generated based on the evaluations and metrics calculated earlier. Finally, the workflow ends 308, delivering these scores as the final assessment of the content quality. In at least one embodiment, the method for guiding the AI engine 116 for the validation of educational content integrates multiple stages of AI-driven analysis to ensure a thorough evaluation of content quality.

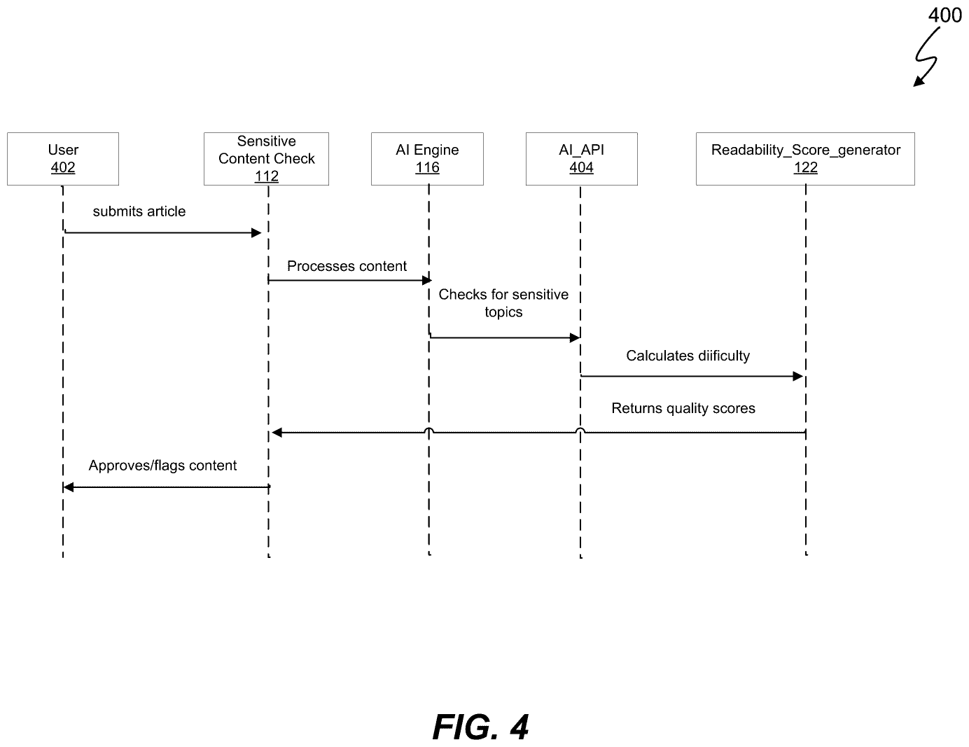

FIG. 4 depicts the process flow for a sensitive content check, 400. The sensitive content check begins with submitting content to the sensitive content check 112. Upon receipt, the sensitive content checks 112 and processes the content by engaging the AI engine 116. The AI engine then interacts with the AI API 404, such as OpenAI, to check for sensitive topics and ensure the content's appropriateness. Additionally, the AI engine 116 assesses the readability score generator 122 and calculates the difficulty level. The content management system 104 receives these readability metrics and quality scores, which summarize the overall quality of the content based on multiple factors. Finally, the quality check pass 130 uses these scores to either approve the content or flag it for issues, sending the result back to the user. This workflow ensures that the content is thoroughly evaluated for quality and suitability before final approval.

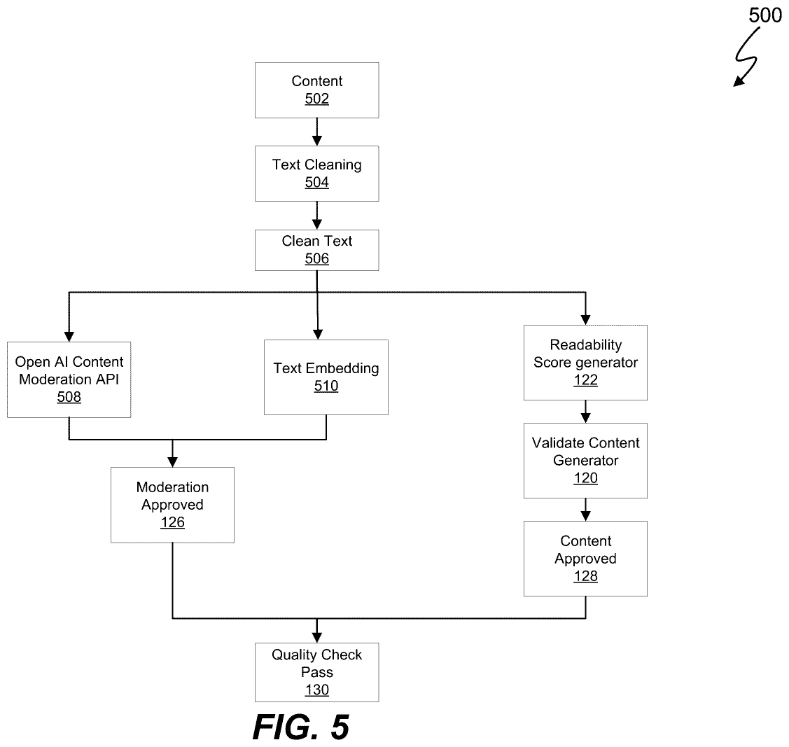

FIG. 5 depicts the process flow chart for the validation of content, a text cleaning 504 cleans the content 502 by removing HTML tags, unnecessary special characters, and extra spaces. For example, the content might look like this: <p>Hello, <b>world!</b>Welcome to our site. </p>. When the text cleaning 504 is applied, text cleaning 504 processes the content by stripping away the HTML tags, removing the extra spaces between words, and eliminating any special characters that aren't needed. After cleaning, the content is transformed into a much simpler and cleaner version: “Hello, world! Welcome to our site.”

The cleaned text is transferred into OpenAI content moderation API 508, text embedding 510, and readability score generator 122. In OpenAI content moderation API 508, the identification of sexual harassment, violence, hate, self-harm topics, self-harm intent, self-harm instruction, violence/graphics, sexual minors, hate/threatning, and harassment/threatening is done, and the API flags the elements. For example, if a piece of content contains threatening language, explicit depictions of violence, references to sexual minors, the API flags these elements.

In a text embedding 510, the embedding 510 system can be used to identify and flag content related to gender identity and political topics. For example, if a piece of content includes phrases like “non-binary” or “transgender rights,” the text embedding process can flag these as related to gender identity. Similarly, if the content contains terms like “liberal policies” or “conservative views,” the system can flag these as related to political topics.

The moderation approved flag 126 receives data from the OpenAI content moderation API 508 and the text embedding 510.

The readability score generator 122 assesses how easy or difficult a text is to understand by evaluating several key factors. The readability score generator 122 considers the average sentence length, with shorter sentences generally being easier to read. The readability score generator 122 also analyzes the complexity of words, flagging those with more syllables as more difficult. Paragraph structure is another factor, with well-organized paragraphs being easier to follow. The metrics count syllables to gauge word difficulty and often estimate the education level required to comprehend the text, typically expressed as a grade level. From the readability score generator 122 the data is given to validate content generator 120 which ensures content is checked for grammar, coherence, factuality, engagement, and age-appropriateness. The readability score generator 122 and validate education content generator 120 send the output data to the content approved 128. The quality check pass 130 receives the data from the moderation approved flag 126 and the content approved 128. The quality check pass 130 decides whether to show the content to the user or not.

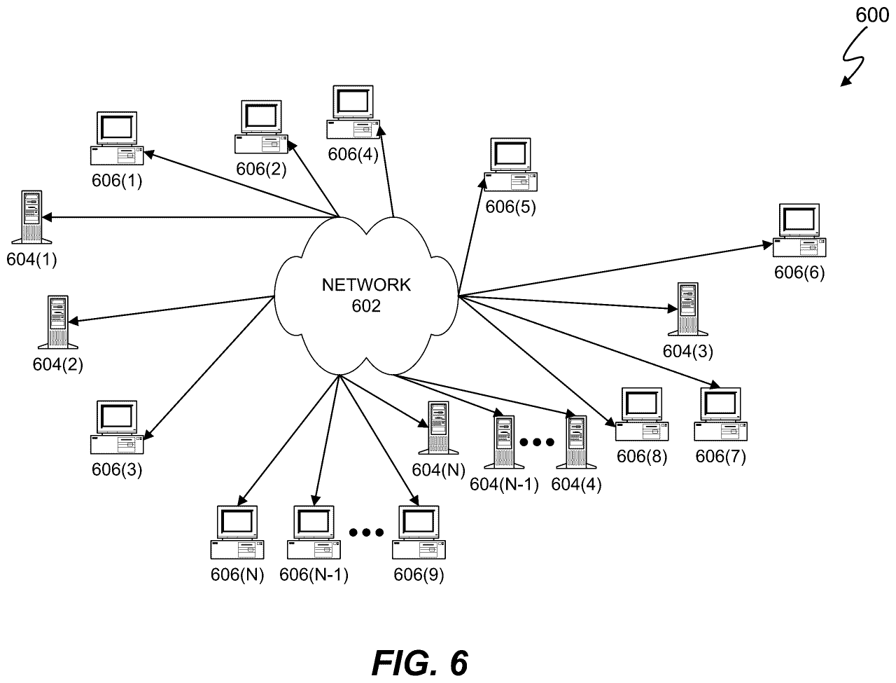

FIG. 6 is a block diagram illustrating a network environment in which a system for guiding an AI engine for the validation of content 100 and a method for guiding an AI engine for the validation of content 200 may be practiced. Network 602 (e.g. a private wide area network (WAN) or the Internet) includes a number of networked server computer systems 604(1)-(N) that are accessible by client computer systems 606(1)-(N), where N is the number of server computer systems connected to the network. Communication between client computer systems 606(1)-(N) and server computer systems 604(1)-(N) typically occurs over a network, such as a public switched telephone network over asynchronous digital subscriber line (ADSL) telephone lines or high-bandwidth trunks, for example communications channels providing TI or OC3 service. Client computer systems 606(1)-(N) typically access server computer systems 604(1)-(N) through a service provider, such as an internet service provider (“ISP”) by executing application specific software, commonly referred to as a browser, on one of client computer systems 606(1)-(N).

Client computer systems 606(1)-(N) and/or server computer systems 604(1)-(N) are specialized computer programmed to improve conventional co puter systems to implement and utilize the system for guiding an AI engine for the validation of content 100 and the method for guiding an AI engine for the validation of content 200. The type of computer system that can be specially programmed to implement and utilize the system for guiding an AI engine for the validation of content 100 and the method for guiding an AI engine for the validation of content 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the system for guiding an AI engine for the validation of content 100 and the method for guiding an AI engine for the validation of content 200 can be implemented using code stored in a tangible, non-transient computer readable medium and executed by one or more processors. In at least one embodiment, the system for guiding an AI engine for the validation of content 100 and the method for guiding an AI engine for the validation of content 200 can be implemented completely in hardware using, for example, logic circuits and other circuits including field programmable gate arrays.

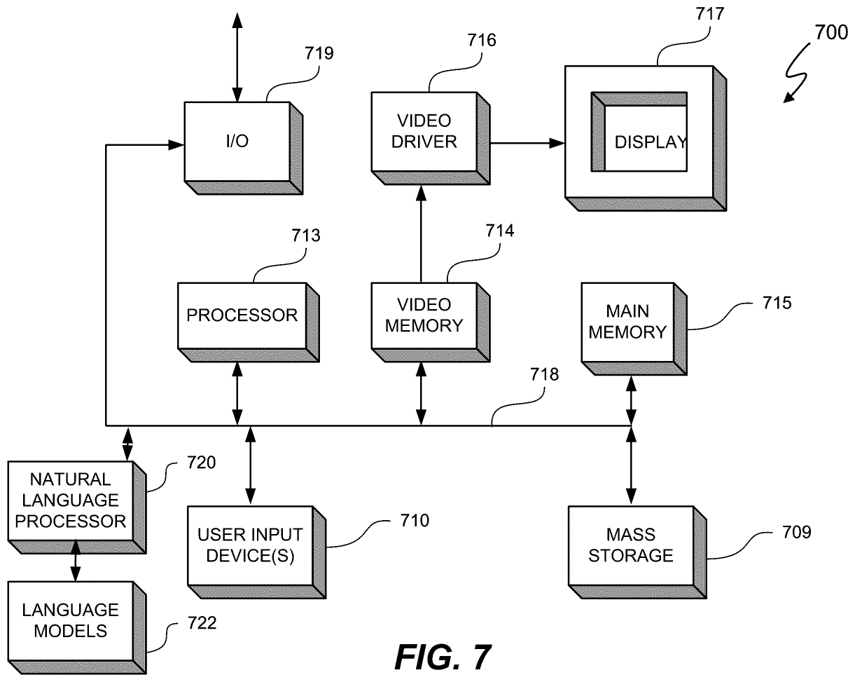

Embodiments of the system for guiding an AI engine for the validation of content 100 and the method for guiding an AI engine for the validation of content 200 can be implemented on a computer system such as a special-purpose, special-programmed computer 700 illustrated in FIG. 7. Input user device(s) 710, such as a keyboard and/or mouse, are coupled to a bi-directional system bus 718. The input user device(s) 710 are for introducing user input to the computer system and communicating that user input to processor 713. The computer system of FIG. 7 generally also includes a non-transitory video memory 714, non-transitory main memory 715, and non-transitory mass storage 709, all coupled to bi-directional system bus 718 along with input user device(s) 710 and processor 713. The mass storage 709 may include both fixed and removable media, such as a hard drive, one or more CDs or DVDs, solid state memory including flash memory, and other available mass storage technology. Bus 718 may contain, for example, 32 of 64 address lines for addressing video memory 714 or main memory 715. The system bus 718 also includes, for example, an n-bit data bus for transferring DATA between and among the components, such as CPU Y09, main memory 715, video memory 714 and mass storage 709, where “n” is, for example, 32 or 64. Alternatively, multiplex data/address lines may be used instead of separate data and address lines.

I/O device(s) 719 may provide connections to peripheral devices, such as a printer, and may also provide a direct connection to a remote server computer systems via a telephone link or to the Internet via an ISP. I/O device(s) 719 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 709, into main memory 715 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 713, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 715 is comprised of dynamic random access memory (DRAM). Video memory 714 is a dual-ported video random access memory. One port of the video memory 714 is coupled to video amplifier 716. The video amplifier 716 is used to drive the display 717. Video amplifier 716 is well known in the art and may be implemented by any suitable means. This circuitry converts pixel DATA stored in video memory 714 to a raster signal suitable for use by display 717. Display 717 is a type of monitor suitable for displaying graphic images.

The computer system described above is for purposes of example only. The system for guiding an AI engine for the validation of content 100 and the method for guiding an AI engine for the validation of content 200 may be implemented in any type of computer system or programming or processing environment. It is contemplated that the system for guiding an AI engine for the validation of content 100 and the method for guiding an AI engine for the validation of content 200 might be run on a stand-alone computer system, such as the one described above. The system for guiding an AI engine for the validation of content 100 and the method for guiding an AI engine for the validation of content 200 might also be run from a server compute system that can be accessed by a plurality of client computer systems interconnected over an intranet network. Finally, the system for guiding an AI engine for the validation of content 100 and the method for guiding an AI engine for the validation of content 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method that integrates programmatic control and a guided and constrained Artificial Intelligence (AI) engine to validate educational content comprising:
executing code using one or more processors of a computer system to cause the computer system to perform operations comprising:
receiving educational content from a content management system for validation, the validation includes grammar, coherence, factuality, engagement, age-appropriateness, and topic suitability;
generating a prompt to guide the AI engine for generating validated educational content by conducting thorough quality checks on the educational content;
transferring the prompt to the AI engine to utilize a plurality of algorithms to conduct thorough quality checks on the educational content to ensure the educational content does not contain inappropriate content related to political, sexual, harassment, violence, hate, and self-harm topics;
integrating readability metrics to assess and assign a measured knowledge grade for the educational content;
generating the validated educational content outlining the results of the quality checks and the measured knowledge grade; and
displaying the generated educational content to a user on an online learning platform.

2. The method of claim 1 further comprising:
utilizing a natural language processing module for analyzing grammar and coherence of the articles.

3. The method of claim 1 wherein utilizing machine learning algorithms to validate factuality and engagement of the educational content.

4. The method of claim 1 further comprising:
employing an age-appropriateness validation module based on the educational level of the user.

5. The method of claim 1 wherein
the AI engine employs an AI embeddings to analyze the articles for content suitability and authenticity.

6. The method of claim 1 further comprises:
integrating an AI moderating API to identify and filter out sensitive topics such as political, sexual, harassment, violence, hate, and self-harm content.
The method of claim 6 wherein utilizing OpenAI's moderator API to verify the appropriateness of content for educational purposes.

7. A system that integrates programmatic control and a guided and constrained Artificial Intelligence (AI) engine to validate educational content comprising:
one or more processors of a computer system; and
a memory, coupled to the one or more processors, storing code that when executed causes the computer system to perform operations comprising:
receiving educational content intended for validation, the validation includes grammar, coherence, factuality, engagement, age-appropriateness, and topic suitability,
generating a prompt to guide the AI engine for generating validated educational content by conducting thorough quality checks on the educational content;
transferring the prompt to the AI engine to utilize algorithms to conduct thorough quality checks on the educational content to ensure the educational content does not contain inappropriate content related to political, sexual, harassment, violence, hate, and self-harm topics;
integrating readability metrics to assess and assign a measured knowledge grade for the educational content; and
generating a detailed report outlining the results of the quality checks and the measured knowledge grade.

8. The system of claim 8 wherein execution of the code causes the computer system to perform further operations comprising:
utilizing a natural language processing module for analyzing grammar and coherence of the articles.

9. The system of claim 8 wherein utilizing machine learning algorithms to validate factuality and engagement of the educational content.

10. The system of claim 8 wherein execution of the code causes the computer system to perform further operations comprising:
employing an age-appropriateness validation module based on the educational level of the user.

11. The system of claim 8 wherein:
the AI engine employs an AI embeddings to analyze the articles for content suitability and authenticity.

12. The system of claim 8 wherein execution of the code causes the computer system to perform further operations comprising:
integrating an AI moderating API to identify and filter out sensitive topics such as political, sexual, harassment, violence, hate, and self-harm content.

13. The system of claim 8 wherein utilizing OpenAI's moderator API to verify the appropriateness of content for educational purposes.
